(19) United States
(12) Patent Application Publication
(10) Pub. No.: US 2010/0250730 A1
(43) Pub. Date: Sep. 30, 2010

(54) AUTOMATED LICENSE RECONCILIATION FOR DEPLOYED APPLICATIONS

(75) Inventors: Steve Menzies, Redmond, WA (US); Bhavini Soneji, Redmond, WA (US); Ashutosh Badwe, Redmond, WA (US); Erik Hedberg, Mercer Island, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/414,898

(22) Filed: Mar. 31, 2009

(51) Int. Cl. G06F 15/16

(52) U.S. Cl. 709/224

(57) ABSTRACT

Systems, methods, and computer program products are described that perform automated license reconciliation for deployed applications. The applications may be deployed among a plurality of computers. Agents are deployed on respective computers to determine the deployed applications. The agents further determine licensable software product identifiers corresponding to the respective instances of the applications. A license data source module provides entitlements corresponding to respective license agreement(s). A reconciliation module matches the entitlements to the instances of the applications to determine whether the instances of the applications are in compliance with the license agreement(s).

### BACKGROUND OF THE INVENTION

1. Field of the Invention

The present invention generally relates to managing software. In particular, the present invention is related to techniques for performing automated license reconciliation for deployed software applications.

2. Background

When a consumer purchases a software application, the consumer is often required to enter a license agreement under which the consumer is allowed to deploy a designated number of instances of the software application. It may be desirable to ensure that the number of deployed instances of the software application does not exceed the number of instances allowed under the license agreement to facilitate compliance with the license agreement.

However, license agreements tend to be rather complex and compliance may not be easily determined, especially when multiple applications and/or license agreements are involved. For example, a consumer may deploy a variety of applications in an application family (e.g., Windows Vista®, Windows XP®, etc. in the Windows® application family) among a plurality of computers. Licenses may be required for each deployed application. Some license agreements may allow prior applications in an application family to be deployed in lieu of the purchased application. Compatibility programs for enabling the purchased applications to be compatible with other applications (e.g., prior applications in the application family) may be deployed on some or all of the computers. Some of the applications may have been upgraded to newer applications in the application family while others have not. Free applications may be deployed in addition to licensable applications, etc.

### SUMMARY

Systems, methods, and computer program products are described herein for performing automated license reconciliation for deployed applications. Agents are loaded on respective computers to determine deployed applications. For example, the deployed applications may be applications physically installed on the computers or installed on virtual machines that are executing on the computers. Each instance of a deployed application is associated with a respective licensable software product identifier. A licensable software product identifier indicates a respective instance of an application (including the version thereof) and license information associated with the application.

License agreements are associated with respective license agreement identifiers. Each license agreement identifier is associated with entitlements that indicate respective instances of software applications that are permitted under the terms of the license agreement with which the license agreement identifier is associated. A reconciliation module matches the entitlements to the licensable software product identifiers to facilitate a determination as to whether the instances of the deployed applications comply with the license agreements.

One example system includes a matching module and a report generation module. The matching module is configured to match entitlements to respective licensable software product identifiers. The entitlements are based on license agreement identifier(s) corresponding to respective license agreement(s) of a customer. The licensable software product identifiers correspond to respective instances of deployed applications. The report generation module is configured to generate a report that indicates whether the applications comply with the license agreement(s) based on whether at least one of the licensable software product identifiers is not matched to a respective entitlement.

In an example method performed by an agent, a determination is made as to instances of applications deployed on a client computer. A licensable software product identifier is determined for each instance of a deployed application indicative of the application and license information associated with the application. Each licensable software product identifier is associated with the client computer to enable a determination of whether the instances of the deployed applications are in compliance with license agreement(s).

In another example method, entitlements are received that are based on license agreement identifier(s) corresponding to respective license agreement(s) of a customer. The entitlements are matched to respective licensable software product identifiers corresponding to respective instances of applications deployed on respective client computers of the customer. A report is generated that indicates whether the instances of the applications comply with the license agreement(s) based on whether at least one of the licensable software product identifiers is not matched to a respective entitlement.

An example computer program product includes a computer-readable medium having computer program logic recorded thereon for enabling a processor-based system to perform automated license reconciliation with respect to deployed applications. The computer program logic includes first and second program logic modules. The first program logic module is for enabling the processor-based system to match entitlements to respective licensable software product identifiers. The entitlements are based on license agreement identifier(s) corresponding to respective license agreement(s) of a customer. The licensable software product identifiers correspond to respective instances of applications deployed on respective client computers of the customer. The second program logic module is for enabling the processor-based system to generate a report that indicates whether the instances of the applications comply with the license agreement(s) based on whether at least one of the licensable software product identifiers is not matched to a respective entitlement.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example license reconciliation system in accordance with an embodiment of the present invention.

FIG. 2 depicts a flowchart of a method for collecting information regarding software inventory in accordance with an embodiment of the present invention.

FIG. 3 is a block diagram of an example implementation of an agent shown in FIG. 1 in accordance with an embodiment of the present invention

FIG. 4 depicts a flowchart of a method for reconciling entitlements with software inventory in accordance with an embodiment of the present invention.

FIG. 5 is a block diagram of an example implementation of the reconciliation module shown in FIG. 1 in accordance with an embodiment of the present invention

FIG. 6 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

### II. Example Embodiments for Automated License Reconciliation

Embodiments of the present invention automate reconciliation of entitlements with software inventory (i.e., deployed software application(s)) to determine whether the software inventory is in compliance with license agreement(s). The entitlements are derived from the license agreement(s) to indicate respective instances of software applications that are permitted under the terms of the license agreement(s).

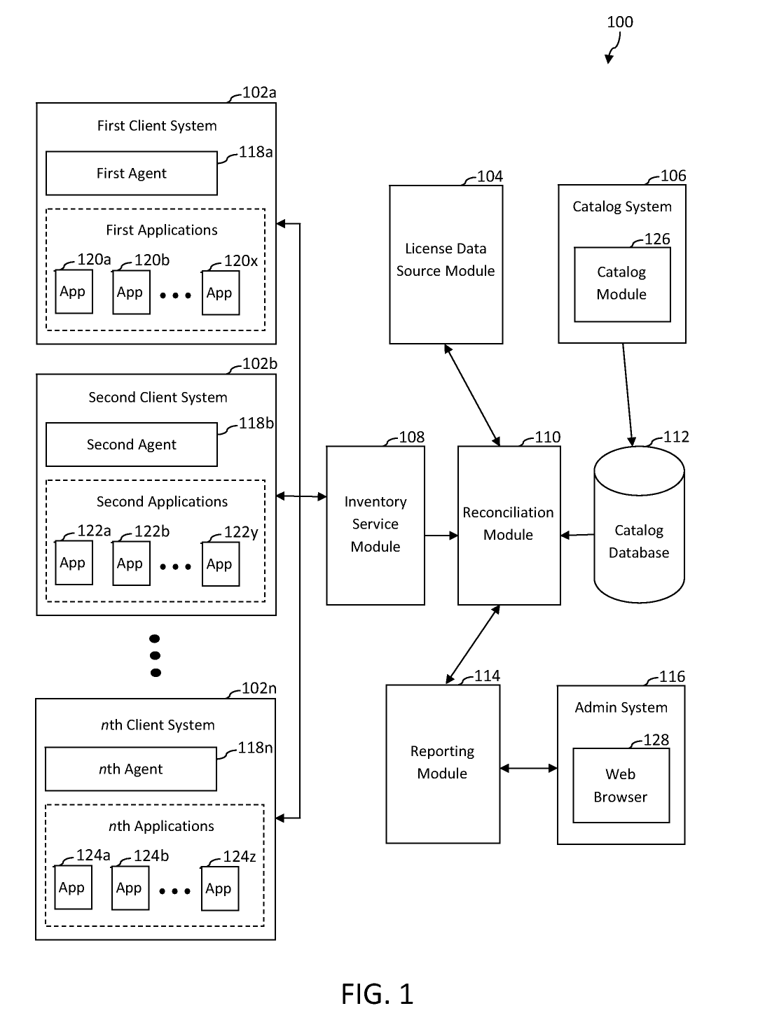

FIG. 1 is a block diagram of an example license reconciliation system 100 in accordance with an embodiment of the present invention. As shown in FIG. 1, license reconciliation system 100 includes a plurality of client systems 102a-102n, a license data source module 104, a catalog system 106, an inventory service module 108, a reconciliation module 110, a catalog database 112, a reporting module 114, and an administrative (admin) system 116. License reconciliation system 100 may be a computer system, though embodiments described herein are not limited in this respect. For example, client systems 102, catalog system 106, and admin system 116 may be computers that communicate with other elements 104, 108, 110, 112, and 114 of FIG. 1 in accordance with any of a variety of protocols, including but not limited to hypertext transfer protocol secure (HTTPS), simple object access protocol (SOAP), and the like. In another example, elements 104, 108, 110, 112, and 114 may be implemented in one or more servers.

One or more applications are deployed on each of client systems 102a-102n of license reconciliation system 100. For example, first applications 120a-120x are deployed on first client system 102a, second applications 122a-122y are deployed on second client system 102b, and so on. It will be recognized that an administrative user of license reconciliation system 100 may deploy applications 120a-120x, 122a-122y, etc. on respective client systems 102a-102n, though the scope of the embodiments is not limited in this respect.

The deployed applications 120a-120x, 122a-122y, etc. may be applications physically installed on client systems 102a-102n or installed on virtual machines that are executing on client systems 102a-102n. Example applications include but are not limited to operating system applications such as Windows Vista®, Windows XP®, Windows 2003®, etc. developed by Microsoft Corporation, Mac OS X®, Mac OS®, etc. developed by Apple, Inc., Solaris®, SunOS®, etc. developed by Sun Microsystems, Inc.; word processing applications such as Word 2007®, Word 2003®, etc. developed by Microsoft Corporation, Pages '09®, Pages '08®, etc. developed by Apple, Inc., WordPerfect X4®, WordPerfect X3®, etc. developed by Corel Corporation, etc.; computer aided design (CAD) applications such as AutoCAD 2009®, AutoCAD 2008®, etc. developed by Autodesk, Inc., MacDraft Pro®, MacDraft PE®, etc. developed by Microspot Ltd.; and any other of the multitude of licensable applications that are available.

Client systems 102a-102n each include a corresponding one of the agents 118a-118n. For instance, an administrative user of license reconciliation system 100 may deploy agents 118a-118n on respective client systems 102a-102n. Agents 118a-118n are configured to determine which applications are deployed on respective client systems 102a-102n. Agents 118a-118n may be configured to run in the background environment of respective client systems 102a-102n, though the scope of the embodiments is not limited in this respect.

Agents 118a-118n are configured to determine licensable software product identifiers corresponding to respective instances of the applications. A licensable software product identifier indicates a respective instance of an application (including the version thereof) and license information associated with the application. For example, a licensable software product identifier may be generated based on the activation code of the respective instance of an application when the application is installed on a respective client system 102. For instance, the licensable software product identifiers may be cryptographically related to the respective activation codes. The license information may include a type of license associated with the application, the license number, the name of the license, etc. The type of the license may be a retail license or a volume license, to provide some examples. The type of the license may indicate terms such as per-computer in a single network, only for specific computer(s), unlimited copies per site, etc.

Each agent 118 is configured to detect applications deployed on the respective client system 102, and to determine the corresponding licensable software product identifiers. For instance, first agent 118a may detect first applications 120a-120x and corresponding licensable software product identifiers, second agent 118b may detect second applications 122a-122y and corresponding licensable software product identifiers, and so on. Agents 118a-118n may be configured to determine locations at which the respective licensable software product identifiers are stored. In an embodiment, agents 118a-118n may review metadata associated with the respective applications 120a-120x, 122a-122y, etc. to determine the locations of the respective licensable software product identifiers.

Agents 118a-118n are also configured to associate the detected applications with the respective client systems 102a-102n on which the applications are deployed. For instance, first agent 118a associates first applications 120a-120x with first client system 102a, second agent 118b associates second applications 122a-122y with second client system 102b, and so on. For instance, each agent 118 may generate a table or other data structure listing the applications detected to be deployed on the corresponding client system 102, which may be stored on the client system 102. Each agent 118 is configured to upload the data structure listing the licensable software product identifiers for the corresponding client system 102 to inventory service module 108, which essentially caches the licensable software product identifiers for processing by reconciliation module 110. Agents 118a-118n may upload the respective identifiers in accordance with a predetermined schedule (e.g., hourly, daily, etc.), though the scope of the embodiments is not limited in this respect. Inventory service module 108 is configured to provide the licensable software product identifiers received for each client system 102 to reconciliation module 110 for further processing.

An administrative user may upload license agreement identifiers corresponding to respective license agreements to reporting module 114 using Web browser 128 (or other client) installed on admin system 116. A license agreement identifier identifies a license agreement, so that entitlements associated with the license agreement may be determined. The entitlements indicate respective instances of software applications that are permitted under the terms of the license agreement. A license agreement identifier may correspond to more than one entitlement. For example, a license agreement that entitles a user to deploy a plurality of instances of one or more applications has a license agreement identifier that corresponds to a plurality of respective entitlements.

An administrative user may enter the license agreement identifiers manually or import the identifiers from a spreadsheet. Admin system 116 executes Web browser 128 to provide a graphical interface that facilitates the administrative user's uploading of the license agreement identifiers. The administrative user may subsequently upload additional license agreement identifiers for reconciliation. For instance, not all of the license agreement identifiers necessarily need to be uploaded at the same time. Reporting module 114 is configured to provide the uploaded license agreement identifiers to reconciliation module 110 for further processing.

Reconciliation module 110 is configured to provide the license agreement identifiers that are received from reporting module 114 to license data source module 104. According to an example embodiment, license data source module 104 is configured to determine entitlements corresponding to the respective license agreement identifiers in accordance with the terms of the respective license agreements. For example, license data source module 104 may store a table or other data structure that cross-references license agreement identifiers with corresponding entitlements. In accordance with this example, license data source module 104 may search the table to determine the entitlements that correspond to the respective license agreement identifiers. It will be recognized by persons skilled in the relevant art(s), however, that the entitlements corresponding to the respective license agreements may be provided by any of a variety of sources. For instance, a user may enter and/or edit entitlements in license data source module 104 using a Web browser or other client.

A research user of license reconciliation system 100 may correlate standard software identifiers to respective licensable software product identifiers using catalog module 126 installed on catalog system 106. A standard software identifier provides a product name and version number for a corresponding application; whereas, a licensable software product identifier may be a string of numbers and/or characters that identifies the application. Catalog system 106 is capable of matching the licensable software product identifiers with their corresponding standard software identifiers. The standard software identifiers may be created by the research user or the developers of the respective applications to facilitate identification of the respective applications. Catalog module 126 stores the standard software identifiers in catalog database 112.

Reconciliation module 110 matches entitlements received from license data source module 104 to licensable software product identifiers received from inventory service module 108. Entitlements may be generated by humans and may therefore include errors or variations with respect to the names of the applications with which the entitlements correspond, for example. Reconciliation module 110 is capable of associating an entitlement with a standard software identifier based on a relationship between the entitlement and the standard software identifier. For example, reconciliation module 110 may be configured to recognize that an entitlement including a misspelled product name is intended to indicate an application having a standard software identifier that reflects the correct spelling of the product name. In this example, reconciliation module 110 matches the entitlement to the licensable software product identifier corresponding to the standard software identifier that reflects the correct spelling.

Reconciliation module 110 may be configured to address errors and/or variations in licensable software product identifiers. For example, reconciliation module 110 may be capable of associating a licensable software product identifier that includes an error with an entitlement based on a relationship between the licensable software product identifier and the entitlement. In this example, reconciliation module 110 may be configured to recognize that the licensable software product identifier that includes the error is intended to indicate an application corresponding to the entitlement.

In one example, an entitlement that entitles a user to deploy an instance of Microsoft's Windows Vista® application may be matched to a licensable software product identifier corresponding to an instance of the Windows Vista® application. In another example, an entitlement that entitles the user to deploy an instance of Microsoft's Word 2007® application may be matched to a licensable software product identifier corresponding to an instance the Word 2007® application. Reconciliation module 110 may match the entitlements to the licensable software product identifiers using SQL join operations, though the scope of the embodiments is not limited in this respect. Reconciliation module 110 may be configured to apply any of a variety of rules to facilitate license reconciliation in accordance with embodiments described herein. For example, a rule may indicate that a license agreement allows an alternative application(s) to be deployed in lieu of a purchased application. In accordance with this example, reconciliation module 110 may perform a down-level rights determination operation to determine the alternative application(s) and to match the alternative application(s) to respective entitlement(s). For example, if a license for a Windows Vista® application allows a user to deploy a Windows XP® application, a Windows 2003® application, or a Windows 2000® application in lieu of the Windows Vista® application, reconciliation module 110 first attempts to match an entitlement corresponding to the purchased application (e.g., the Windows Vista® application in this example) to a corresponding licensable software product identifier among the licensable software product identifiers received from inventory service module 108.

If a match is not made, reconciliation module 110 performs a follow-up operation in which reconciliation module 110 attempts to match an entitlement corresponding to a first alternative application (e.g., the Windows XP® application in this example) to a licensable software product identifier corresponding to the first alternative application among the licensable software product identifiers received from inventory service module 108. If a match is not made, reconciliation module 110 performs the follow-up operation with respect to a second alternative application (e.g., the Windows 2003® application in this example), and so on until a match is made or a follow-up operation has been performed with respect to each of the alternative applications.

In another example, a rule may indicate that a secondary application that is included in a purchased application does not require an entitlement in addition to the entitlement that corresponds to the purchased application. In accordance with this example, reconciliation module 110 may be configured to exclude a licensable software product identifier corresponding to the secondary application from a compliance determination analysis.

Reconciliation module 110 may take into account any of a variety of other information to determine whether the terms of license agreement(s) have been violated. For instance, reconciliation module 110 may consider the current date, whether upgrades have been performed with respect to any one or more of the deployed applications, etc.

In an embodiment, reconciliation module 110 may be configured to match the licensable software product identifiers received from inventory service module 108 to respective standard software identifiers stored in catalog database 112. In accordance with this embodiment, reconciliation module 110 may match the entitlements received from license data source module 104 to the respective standard software identifiers.

According to another embodiment, reconciliation module 110 may be configured to map an entitlement to an application name associated with a standard software identifier. For example, reconciliation module 110 may store a plurality of different spellings for the name of an application. An entitlement corresponding to the application may be associated with a first spelling in the plurality of spellings. The standard software identifier corresponding to the application may be associated with a second spelling in the plurality of spellings. In this example, reconciliation module 110 may be configured to map the entitlement to the second spelling.

If reconciliation module 110 is unable to match a licensable software product identifier that is received from inventory service module 108 to any of the entitlements corresponding to the license agreement(s), reconciliation module 110 determines that the instance of the application corresponding to that licensable software product identifier is not in compliance with the terms of the license agreement(s). For instance, reconciliation module 110 may be unable to match a standard software identifier corresponding to the licensable software product identifier to any of the entitlements.

If reconciliation module 110 is unable to find an entitlement that corresponds to a licensable software product identifier, but a corresponding standard software identifier is stored in catalog database 112, the licensable software product identifier is treated as if the entitlement count is zero for the corresponding application. For example, a Microsoft Office 2003® reader application that is included in a Microsoft Office 2007® application does not require a separate license. Although a standard software identifier for the Microsoft Office 2003® reader application may be stored in catalog database 112, an entitlement for the reader application may not be provided. In accordance with this example, the entitlement count for the reader application is zero.

If reconciliation module 110 is unable to find an entitlement that corresponds to a licensable software product identifier, and catalog database 112 does not include a standard software identifier that corresponds to the licensable software product identifier, reconciliation module 110 may store the licensable software product identifier and corresponding application instance in a portion of catalog database 112 (or another element of license reconciliation system 100) that can be later researched by an administrative user of license reconciliation system 100 to determine whether license data source module 104 and/or catalog database 112 are missing information regarding the application that corresponds to the licensable software product identifier. License data source module 104 and/or catalog module 126 may be configured to enable the administrative user to update any missing information.

Reconciliation module 110 may be configured to remove an association between a licensable software product identifier and an entitlement in response to the licensable software product identifier including license information that is not consistent with the license agreement from which the entitlement was derived.

Reconciliation module 110 generates a report that indicates whether applications 120a-120n, 122a-122n, etc. deployed on respective client systems 102a-102n are in compliance with the terms of the license agreement(s). The report may include a listing of applications 120a-120n, 122a-122n, etc., the entitlements received from license data source module 104, and an indication as to which instances of the applications match which entitlements. The report may further include a listing of application instances that do not comply with the terms of the license agreement(s). Reporting module 114 may be configured to enable the administrative user to view the report using Web browser 128 (or other client) installed on admin system 116. Reconciliation module 110 may be accessible over a communication network, such as the Internet, though the scope of the embodiments is not limited in this respect.

In one example implementation, client systems 102a-102n may be virtual machines. According to another example implementation, a client system 102 may run a plurality of operating systems (OSs). In further accordance with this example implementation, reconciliation module 110 may generate a plurality of reports corresponding to the plurality of respective operating systems.

Although one license database source module 104, one catalog system 106, and one admin system 116 are depicted in FIG. 1, persons skilled in the relevant art(s) will recognize that license reconciliation system 100 may include any number of license database source modules, catalog systems, and/or admin systems. For example, reconciliation module 110 may be capable of processing a variety of different data representations provided by respective license database source modules.

In accordance with this example, reconciliation module 110 may be capable of converting the different data representations into a common format.

### III. Example Agent

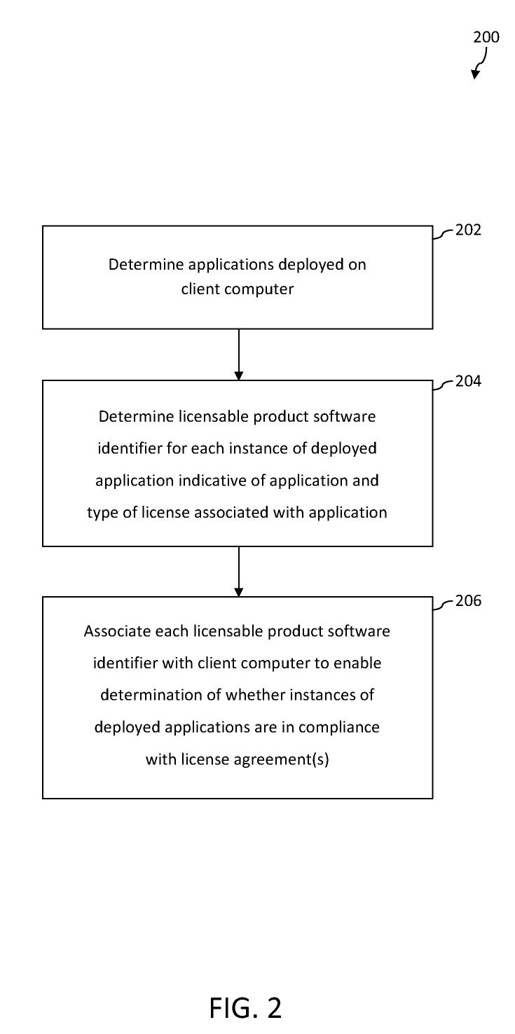

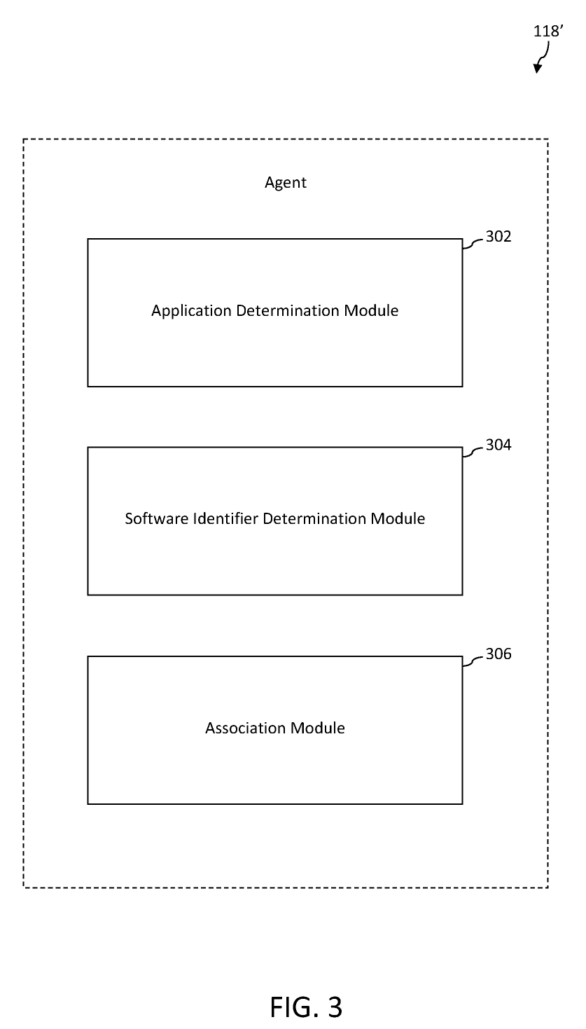

FIG. 2 depicts a flowchart 200 of a method for collecting information regarding software inventory in accordance with an embodiment of the present invention. Flowchart 200 may be performed by each agent 118 of license reconciliation system 100 shown in FIG. 1, for example. For illustrative purposes, flowchart 200 is described with respect to an agent 118′ shown in FIG. 3, which is an example of an agent 118, according to an embodiment of the present invention. As shown in FIG. 3, agent 118′ includes an application determination module 302, a software identifier determination module 304, and an association module 306. Further structural and operational embodiments will be apparent to persons skilled in the relevant art(s) based on the discussion regarding flowchart 200. Flowchart 200 is described as follows.

As shown in FIG. 2, the method of flowchart 200 begins at step 202. In step 202, applications deployed on a client computer are determined. For example, in an embodiment, application determination module 302 may be configured to determine applications deployed on a client computer on which agent 118′ is running. For instance, application determination module 302 may read a configuration file, group policy setting(s), registry setting(s), or the like associated with the client computer to determine the deployed applications.

At step 204, a licensable software product identifier is determined for each instance of a deployed application indicative of the application and license information associated with the application. For instance, in an embodiment, software identifier determination module 304 may be configured to determine the licensable software product identifier for each instance of a deployed application. For example, software identifier determination module 304 may read metadata associated with the respective deployed applications to determine locations at which the respective licensable software product identifiers for the respective instances of the deployed applications are stored.

At step 206, each licensable software product identifier is associated with the client computer to enable a determination of whether the instances of the deployed applications are in compliance with terms of one or more license agreements. For example, in an embodiment, association module 306 may associate each licensable software product identifier with the client computer. It should be noted that the method of flowchart 200 may be performed concurrently by a plurality of agents, such as agents 118a-118n, with respect to applications deployed on the respective client computers on with the respective agents are running, though the scope of the embodiments is not limited in this respect.

### IV. Example Reconciliation Module

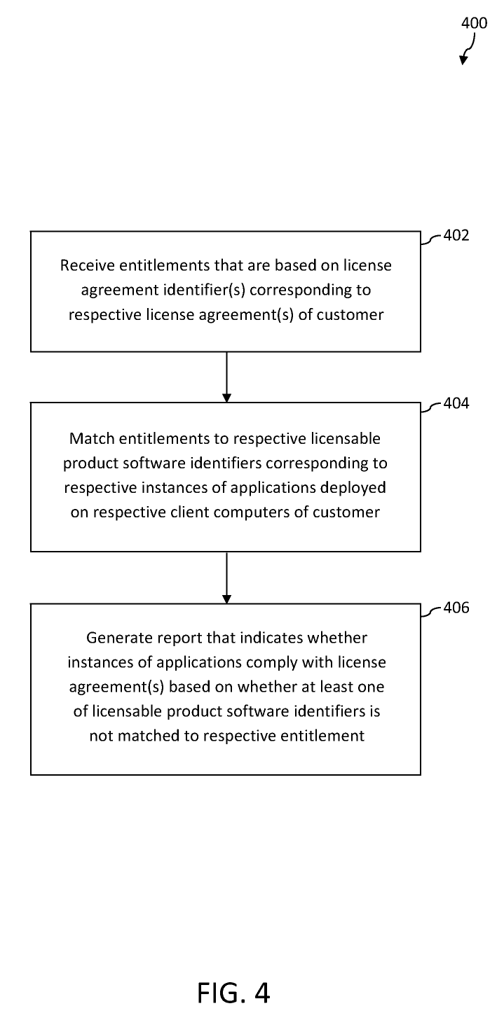

FIG. 4 depicts a flowchart 400 of a method for reconciling entitlements with software inventory in accordance with an embodiment of the present invention.

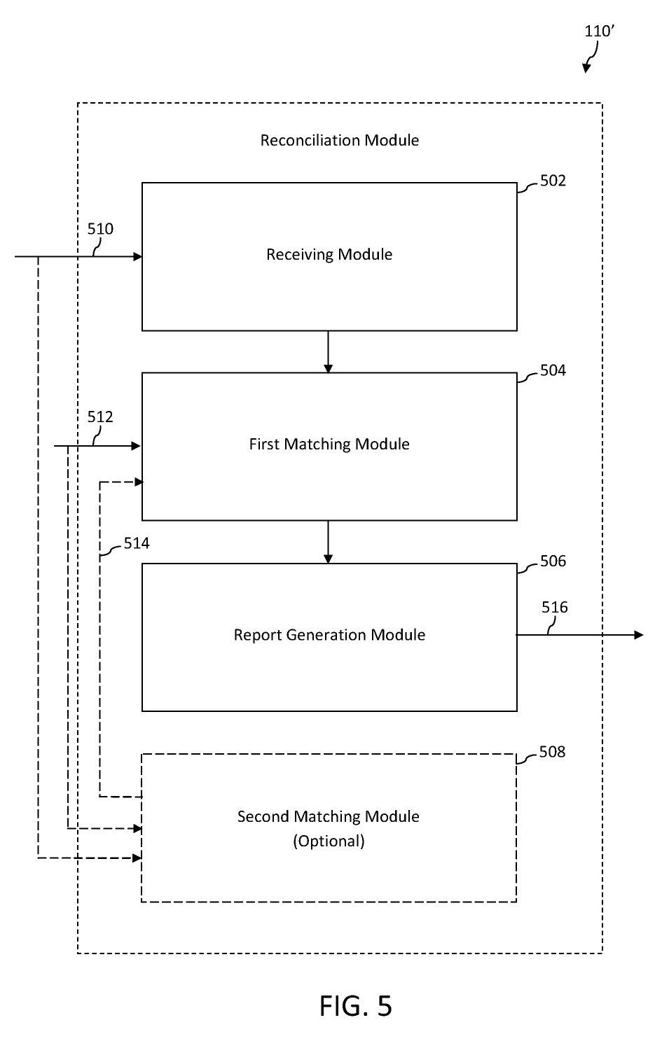

Flowchart 400 may be performed by a reconciliation module 110 of license reconciliation system 100 shown in FIG. 1, for example. For illustrative purposes, flowchart 400 is described with respect to a reconciliation module 110′ shown in FIG. 5, which is an example of reconciliation module 110, according to an embodiment of the present invention. As shown in FIG. 5, reconciliation module 110′ includes a receiving module 502, a first matching module 504, a report generation module 506, and an optional second matching module 508. Further structural and operational embodiments will be apparent to persons skilled in the relevant art(s) based on the discussion regarding flowchart 400. Flowchart 400 is described as follows.

As shown in FIG. 4, the method of flowchart 400 begins at step 402. In step 402, entitlements are received that are based on one or more license agreement identifiers corresponding to respective one or more license agreements of a customer. For example, in an embodiment, receiving module 502 may be configured to receive entitlements 510 that are based on the one or more license agreement identifiers corresponding to the respective one or more license agreements of the customer. Receiving module 502 may receive entitlements 510 from license data source module 104, a user, or another source.

At step 404, the entitlements are matched to respective licensable software product identifiers corresponding to respective instances of applications deployed on respective client computers of the customer. For instance, in an embodiment, first matching module 504 may be configured to match entitlements 510 to respective licensable software product identifiers 512 corresponding to respective instances of applications deployed on the respective client computers of the customer.

For example, first matching module 504 may match the entitlements 510 to the respective licensable software product identifiers 512 in accordance with a down-level rights determination technique or any other suitable technique. In accordance with this example, first matching module 504 may determine that a plurality of entitlements correspond to a license agreement identifier. If a first entitlement of the plurality of entitlements does not match a licensable software product identifier, first matching module 504 may attempt to match a second entitlement of the plurality of entitlements to the licensable software product identifier. If the second entitlement of the plurality of entitlements does not match the licensable software product identifier, first matching module 504 may attempt to match a third entitlement of the plurality of entitlements to the licensable software product identifier, and so on.

At step 406, a report is generated that indicates whether the instances of the applications comply with terms of the one or more license agreements based on whether at least one of the licensable software product identifiers is not matched to a respective entitlement. For example, in an embodiment, report generation module 506 may be configured to generate report 516 indicating whether the instances of the applications comply with terms of the one or more license agreements. In an embodiment, report 516 includes a list, each row of which indicates an instance of an application and a corresponding license and/or entitlement (or an indication that no license and/or entitlement corresponds to the instance). An example list is provided below in accordance with this embodiment.

| | Application | Computer | License |
|---|---|---|---|
| 1 | Windows 2003 ® | Second client system 102b | (None) |
| 2 | Windows XP ® | First client system 102a | Windows Vista ® |
| | | | license 20080314 |
| 3 | Windows Vista ® | nth client system 102n | Windows Vista ® |
| | | | license 20080314 |
| . | . | . | . |
| . | . | . | . |
| . | . | . | . |

The example list provided above indicates that an instance of a Windows 2003® application is deployed on second client system 102b, and no entitlement is matched to the instance. Accordingly, the instance of the Windows 2003® application does not comply with the terms of the license agreement(s) upon which the list is based.

For example, the report 516 may indicate a non-compliance if the number of licensable product software identifiers 512 exceeds the number of entitlements 510. In another example, the report 516 may specify each of the applications or each instance of the applications that does not comply with the terms of the one or more license agreements. In yet another example, the report 516 may specify the number of instances of the applications that do not comply with the terms of the one or more license agreements based on the number of licensable product software identifiers 512 that are not matched to respective entitlements 510.

In an example implementation, optional second matching module 508 of reconciliation module 110′ may be configured to match the licensable software product identifiers 512 to respective standard software identifiers 514 stored in catalog database 112, for example. In accordance with this example implementation, first matching module 504 may match the entitlements 510 that are received by receive module 502 at step 402 to the respective standard software identifiers 514 at step 504. In further accordance with this example implementation, report generation module 506 may generate the report 516 based on whether at least one of the standard software identifiers 514 is not matched to a respective entitlement 510.

In another example implementation, optional second matching module 508 may be configured to map entitlements 510 to respective application names associated with respective standard software identifiers 514. For instance, optional second matching module 508 may map the entitlements 510 based on a relationship between the entitlements 510 and the respective standard software identifiers 514.

Embodiments described herein have a variety of benefits, as compared to conventional license reconciliation techniques. For example, embodiments automate the process of determining license compliance. Embodiments may automate any one or more sub-processes that may be utilized to determine license compliance, such as information gathering with respect to deployed applications, determining entitlements based on license agreements, matching the entitlements to instances of the deployed applications, etc.

With respect to information gathering, embodiments automate the discovery of new applications or instances thereof and corresponding licensable software product identifiers. Rather than require software vendors to publish products and uniquely identify them using a standard scheme for which the vendors may have little immediate incentive, embodiments are capable of dynamically collecting new licensable software product identifiers. For example, license reconciliation system 100 may be configured to process the licensable software product identifiers asynchronously to enable accurate association and identification of licensable products in the automated reconciliation reports generated by reconciliation module 110.

Embodiments enable agents 118a-118n to review metadata associated with deployed applications to determine the locations of respective licensable software product identifiers. Enabling agents 118a-118n in this manner may eliminate the need for an administrator to take an action, such as redeploying or updating agents 118a-118n.

With respect to matching the entitlements, embodiments are capable of performing a down-level rights determination technique to further automate license reconciliation. Embodiments may be capable of providing information indicating a cause of non-compliance with the terms of the license agreement(s).

Embodiments are operable with a plurality of different software vendors. For example, agents 118a-118n may be updated to implement different detections algorithms for the different vendors and to look in different locations to collect information for the respective vendors. License data source module 104 may be expanded to communicate with the licensing services of the respective software vendors. An administrative user of license reconciliation system 100 may update agents 118a-118n and/or license data source module 104 as described above. For example, agents 118a-118n may be updated remotely. In this example, the administrative user may alter one or more configuration files, group policy setting(s), registry setting(s), or the like to update agents 118a-118n.

### V. Further Example System Embodiments

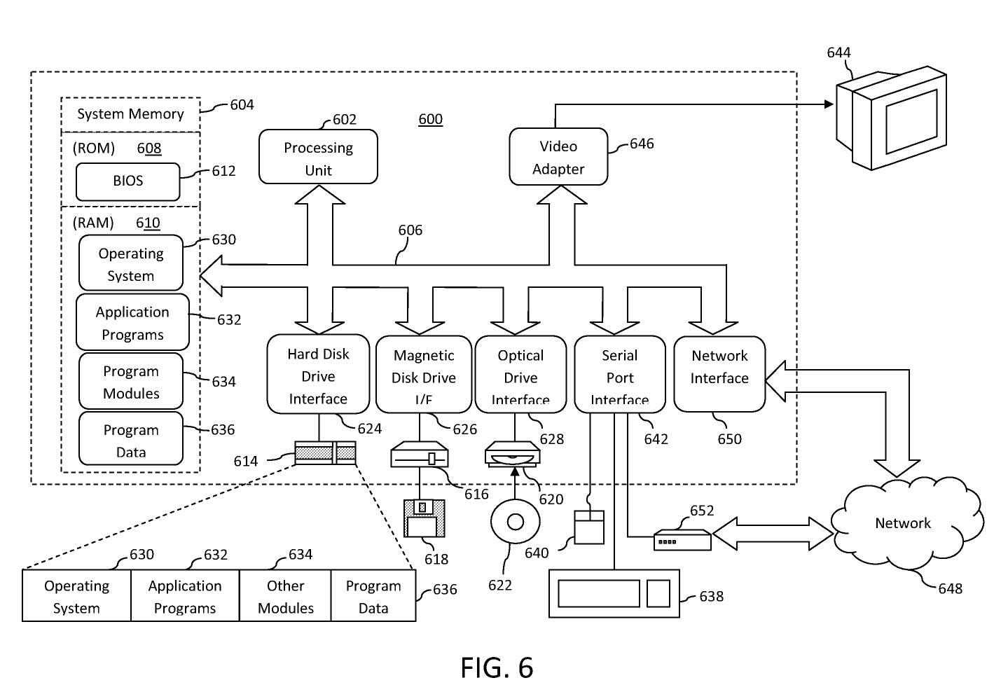

FIG. 6 depicts an exemplary implementation of a computer 600 in which embodiments of the present invention may be implemented. Any one or more of client systems 102, license data source module 104, catalog system 106, inventory service module 108, reconciliation module 110, reporting module 114, and/or admin system 116 shown in FIG. 1 may be implemented similarly to computer 600, including one or more features of computer 600 and/or alternative features. Computer 600 may be a general-purpose computing device in the form of a conventional personal computer, a mobile computer, or a workstation, for example, or computer 600 may be a special purpose computing device. The description of computer 600 provided herein is provided for purposes of illustration, and is not intended to be limiting. Embodiments of the present invention may be implemented in further types of computer systems, as would be known to persons skilled in the relevant art(s).

As shown in FIG. 6, computer 600 includes a processing unit 602, a system memory 604, and a bus 606 that couples various system components including system memory 604 to processing unit 602. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system 612 (BIOS) is stored in ROM 608.

Computer 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 630, one or more application programs 632, other program modules 634, and program data 636. Application programs 632 or program modules 634 may include, for example, computer program logic for implementing agents 118, applications 120, 122, 124, etc., license data source module 104, inventory service module 108, reconciliation module 110, reporting module 114, catalog module 126, application determination module 302, software identifier determination module 304, association module 306, receiving module 502, first matching module 504, report generation module 506, optional second matching module 508, flowchart 200 (including any step of flowchart 200), and flowchart 400 (including any step of flowchart 400), as described above.

A user may enter commands and information into the computer 600 through input devices such as keyboard 638 and pointing device 640. Other input devices (not shown) may include a microphone, joystick, game pad, satellite dish, scanner, or the like. These and other input devices are often connected to the processing unit 602 through a serial port interface 642 that is coupled to bus 606, but may be connected by other interfaces, such as a parallel port, game port, or a universal serial bus (USB).

A monitor 644 or other type of display device is also connected to bus 606 via an interface, such as a video adapter 646. In addition to the monitor, computer 600 may include other peripheral output devices (not shown) such as speakers and printers.

Computer 600 is connected to a network 648 (e.g., the Internet) through a network interface or adapter 650, a modem 652, or other means for establishing communications over the network. Modem 652, which may be internal or external, is connected to bus 606 via serial port interface 642.

As used herein, the terms “computer program medium” and “computer-readable medium” are used to generally refer to media such as the hard disk associated with hard disk drive 614, removable magnetic disk 618, removable optical disk 622, as well as other media such as flash memory cards, digital video disks, random access memories (RAMs), read only memories (ROM), and the like.

As noted above, computer programs and modules (including application programs 632 and other program modules 634) may be stored on the hard disk, magnetic disk, optical disk, ROM, or RAM. Such computer programs may also be received via network interface 650 or serial port interface 642. Such computer programs, when executed or loaded by an application, enable computer 600 to implement features of embodiments of the present invention discussed herein. Accordingly, such computer programs represent controllers of the computer 600.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An automated method performed by an automated software agent comprising:
determining applications deployed on a client computer;
determining a licensable software product identifier for each instance of a deployed application indicative of the application and license information associated with the application; and
associating each licensable software product identifier with the client computer to enable a determination of whether the instances of the deployed applications are in compliance with one or more license agreements.

2. The method of claim 1, wherein determining the applications comprises:
reading a configuration file, group policy setting, or registry setting associated with the client computer to determine the deployed applications.

3. The method of claim 1, wherein determining the licensable software product identifier for each deployed application comprises:
reading metadata associated with the respective deployed applications to determine locations at which the respective licensable software product identifiers for the respective instances of the deployed applications are stored.

4. An automated method comprising:
receiving entitlements that are based on one or more license agreement identifiers corresponding to respective one or more license agreements of a customer;
matching the entitlements to respective licensable software product identifiers corresponding to respective instances of applications deployed on respective client computers of the customer; and
generating a report that indicates whether the instances of the applications comply with the one or more license agreements based on whether at least one of the licensable software product identifiers is not matched to a respective entitlement.

5. The method of claim 4, wherein generating the report comprises:
responsive to a number of the licensable software product identifiers exceeding a number of the entitlements, generating the report to indicate that at least one instance of the deployed applications is not in compliance with the one or more license agreements.

6. The method of claim 4, wherein matching the entitlements to the respective licensable software product identifiers is performed in accordance with a down-level rights determination technique.

7. The method of claim 4, further comprising:
matching the licensable software product identifiers to respective standard software identifiers;
wherein matching the entitlements includes matching the entitlements to the respective standard software identifiers.

8. The method of claim 7, wherein matching the entitlements to the respective standard software identifiers comprises:
reviewing a plurality of alternative spellings of at least one of the entitlements to match the at least one of the entitlements to a respective at least one of the standard software identifiers.

9. A computer program product comprising a computer-readable medium having computer program logic recorded thereon for enabling a processor-based system to perform automated license reconciliation with respect to deployed applications, comprising:
a first program logic module for enabling the processor-based system to match entitlements that are based on one or more license agreement identifiers corresponding to respective one or more license agreements of a customer to respective licensable software product identifiers corresponding to respective instances of applications deployed on respective client computers of the customer; and
a second program logic module for enabling the processor-based system to generate a report that indicates whether the instances of the applications comply with the one or more license agreements based on whether at least one of the licensable software product identifiers is not matched to a respective entitlement.

10. The computer program product of claim 9, wherein the second program logic module includes instructions for enabling the processor-based system to generate the report to indicate that at least one instance of the deployed applications is not in compliance with the one or more license agreements in response to a number of the licensable software product identifiers exceeding a number of the entitlements.

11. The computer program product of claim 9, wherein the first program logic module includes instructions for enabling the processor-based system to perform a down-level rights determination operation to match the entitlements to the respective licensable software product identifiers.

12. The computer program product of claim 9, further comprising:
a third program logic module for enabling the processor-based system to match the licensable software product identifiers to respective standard software identifiers;
wherein the first program logic module includes instructions for enabling the processor-based system to match the entitlements to the respective standard software identifiers.

13. The computer program product of claim 12, wherein the instructions for enabling the processor-based system to match the entitlements to the respective standard software identifiers comprise:
instructions for enabling the processor-based system to review a plurality of alternative spellings of at least one of the entitlements to match the at least one of the entitlements to a respective at least one of the standard software identifiers.

14. A system comprising:
a first matching module configured to match entitlements that are based on one or more license agreement identifiers corresponding to respective one or more license agreements of a customer to respective licensable software product identifiers corresponding to respective instances of applications deployed on respective client computers of the customer; and
a report generation module configured to generate a report that indicates whether the instances of the applications comply with the one or more license agreements based on whether at least one instance of the licensable software product identifiers is not matched to a respective entitlement.

15. The system of claim 14, wherein the first matching module is configured to compare a first number of the licensable software product identifiers to a second number of the entitlements; and
wherein the report generation module is configured to generate the report to indicate that at least one instance of the deployed applications is not in compliance with the one or more license agreements if the first number exceeds the second number.

16. The system of claim 14, wherein the report generation module is configured to generate the report to specify each of the applications that does not comply with the one or more license agreements.

17. The system of claim 14, wherein the report generation module is configured to generate the report to indicate a number of instances of the applications that do not comply with the one or more license agreements based on the number of the licensable software product identifiers that are not matched to respective entitlements.

18. The system of claim 14, wherein the first matching module is configured to match the entitlements to the respective licensable software product identifiers in accordance with a down-level rights determination technique.

19. The system of claim 14, further comprising:
a second matching module configured to match the licensable software product identifiers to respective standard software identifiers;
wherein the first matching module is configured to match the entitlements to the respective standard software identifiers.

20. The system of claim 19, wherein the first matching module is configured to review a plurality of alternative spellings of at least one of the entitlements to match the at least one of the entitlements to a respective at least one of the standard software identifiers.
